(19) United States
(12) Patent Application Publication
(10) Pub. No.: US 2017/0322592 A1
(43) Pub. Date: Nov. 9, 2017

(54) RESISTIVE TOUCH INPUT DEVICE

(71) Applicant: HEWLETT-PACKARD DEVELOPMENT COMPANY, L.P., HOUSTON, TX (US)

(72) Inventors: ERIC CHEN, HOUSTON, TX (US); CHAD PATRICK PARIS, HOUSTON, TX (US); HEESANG KIL, HOUSTON, TX (US); KI BOK SONG, HOUSTON, TX (US); WE-YO LU, HOUSTON, TX (US)

(21) Appl. No.: 15/319,480

(22) PCT Filed: Jul. 31, 2014
(86) PCT No.: PCT/US2014/049241

§ 371 Date: Dec. 16, 2016

(51) Int. Cl. G06F 1/16; G06F 3/041; G06F 3/045

(52) U.S. Cl. CPC G06F 1/1616; G06F 3/045; G06F 1/1692; G06F 3/0412

(57) ABSTRACT

An example system includes an input/output interface to receive inputs from one or more input devices and an input device to receive input from a user. The input device includes a resistive touch layer and an organic light emitting diode (OLED) layer.

### BACKGROUND

Devices can have various mechanisms for input. For example, a computing device may have a keyboard and a mouse to allow a user to provide input to the computing device. More recently, technology has allowed input through touch surfaces. In this regard, a user may touch an icon on a surface, such as a touch screen, to provide the input to various devices.

### BRIEF DESCRIPTION OF THE DRAWINGS

For a more complete understanding of various examples, reference is now made to the following descriptions taken in connection with the accompanying drawings in which:

FIG. 1 schematically illustrates an example system having a touch input device;

FIG. 2 illustrates an example system having a touch input device;

FIG. 3 illustrates an example touch input device;

FIGS. 4 and 5 illustrate example contextual keys displayed on example touch input devices; and

FIG. 6 illustrates an example method of using an example resistive touch input device.

### DETAILED DESCRIPTION

Various examples described below provide for touch input devices with an organic light emitting diode (MED) layer provided above a resistive touch layer. This arrangement allows an input region with variable input keys or regions. The OLED layer may be used to display contextual keys which correspond to a particular application. The size, shape and/or content of the keys may be variable and may be associated with the application. The combination of the OLED layer with the resistive touch layer provides for the use of contextual keys with, a reduced latency in response time to a user's input, which may be detected via the resistive touch layer.

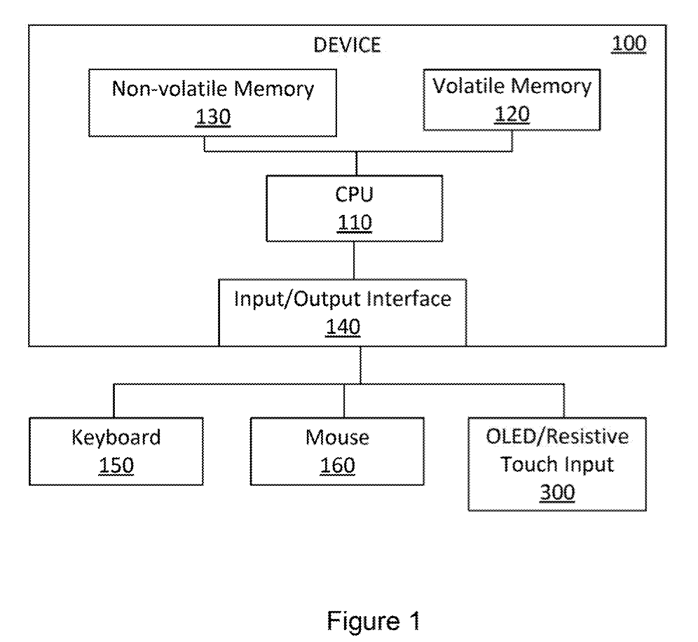

Referring now to FIG. 1, an example system having a touch input device is schematically illustrated. The system may be implemented in a device 100, such as a desktop, laptop, workstation, tablet, smartphone, gaming device, point-of-sale device, or a server. Of course, those skilled in the art will appreciate that the system may be implemented in any of a variety of electronic devices. The example device 100 of FIG. 1 includes a central processing unit (CPU) 110. In various examples, the CPU 110 may control various operations within the device 100. For example, the CPU 110 may execute instructions from an application stored and/or installed on the device 100.

The example device 100 of FIG. 1 is further provided with a volatile memory 120. In various examples, the volatile memory 120 tray be a random access memory (RAM) accessed by the CPU 110 for loading and executing the various applications. The volatile memory 120 may be a static RAM or a dynamic RAM and may be implemented on any of a variety of types of non-transitory storage devices.

A non-volatile memory 130 is provided on the example device 100 of FIG. 1. The non-volatile memory 130 may be used to store various types of information, including stored data and programs, for example. The non-volatile memory 130 may be any of a variety of types of non-transitory storage devices, such as flash memory chips, for example.

The volatile memory 120 and the non-volatile memory 130 are accessed by the CPU 110. As noted above, the CPU 110 may access the volatile memory 120 (e.g., RAM) to load and access applications while executing instructions associated with the applications, for example. The non-volatile memory 130 may be accessed by the CPU 110 to access data that may be used, for example, by the applications. For example, the non-volatile memory 130 may store files for editing by a word processing program.

Information stored in the volatile memory 120 may be available during operation of the device 100, but may be lost when the device 100 is shut down. For example, a program loaded into the volatile memory 120 for use by the CPU 100 may require re-starting each time the device 100 is re-booted. By contrast, information in the non-volatile memory 130 may remain stored in the non-volatile memory 130 even if the device 100 is shut down. Thus, information such as documents, pictures, software or other such data may be stored in the non-volatile memory 130.

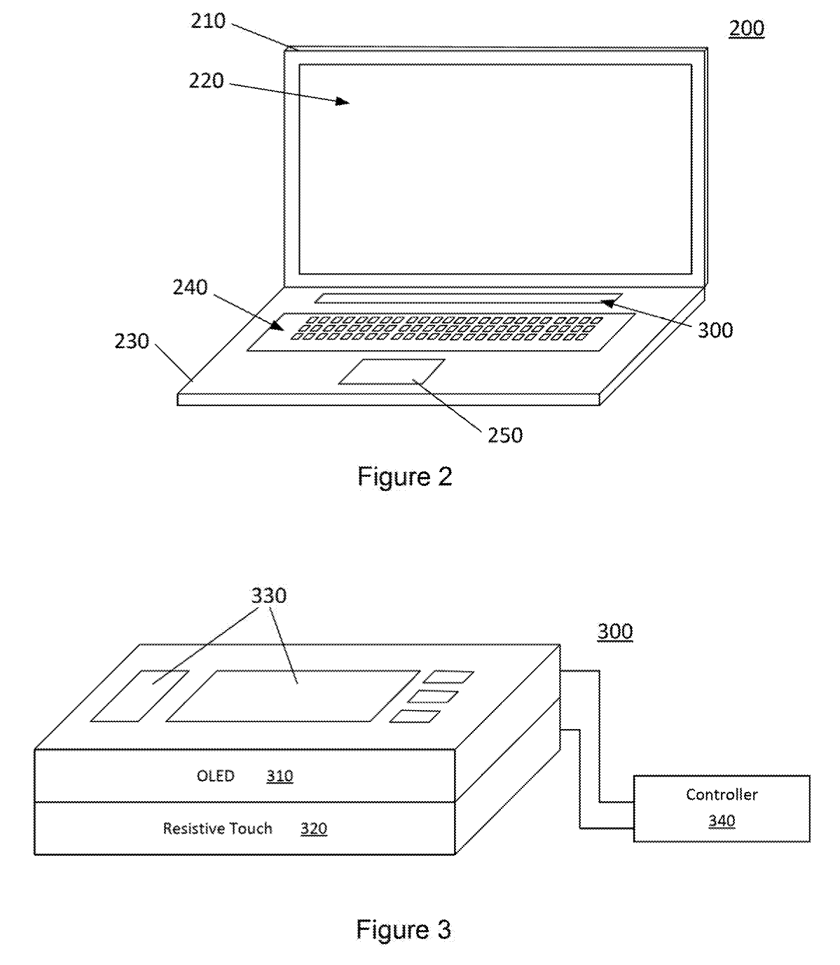

In the example of Figure the device 100 is provided with an input/output interface 140. The example input/output interface 140 may receive inputs from various input devices and provide them to the CPU 110, for example. As shown in FIG. 1, the input/output interface 140 may receive inputs from such input devices as a keyboard 150, a mouse 160 and/or a touch input device 300. An example touch input device 300 is described below with reference to FIGS. 2-5. Those skilled in the art will appreciate that various other input devices may be provided for providing input to the device 100.

Referring now to FIG. 2, an example system having a touch input device is illustrated. As noted above, systems in accordance with the present disclosure may include various types of electronic devices. In the example illustrated in FIG. 2, the system is a laptop computer 200. The laptop computer 200 includes a top portion 210 which includes a display region 220. In various examples, the display region 220 may be a touch screen, such as a capacitive touch screen. The laptop computer 200 also includes a bottom portion 230 which may be provided with a variety of input devices which allow a user to interact with the laptop computer 200 or a processor within the laptop computer 200. In this regard, the bottom portion 230 includes a keyboard 240, which may be a standard QWERTY keyboard and may optionally include a numeric keypad. Additionally, the bottom portion 250 may be provided with a touch pad 250 to control the position of a cursor on the display region 220, for example. In various examples, the touch pad 250 may replace a mouse that may be externally connected to the laptop computer 200. When the mouse is connected to the laptop computer 200, the touch pad 250 may be disabled. The laptop computer 200 is also provided with a touch input device 300 which may be provided with variable contextual keys, as described in greater detail below with reference to FIGS. 3-5.

Referring now to FIG. 3, an example touch input device 300 is illustrated. The touch input device 300 is provided with an organic light emitting diode (OLED) layer 310 which can be used as a display region for displaying, various items to the user of the laptop 200, for example. An OLED is an LED with a film of an organic compound which emits light in response to an electric current. An OLED can be superior to other types of displays, such as liquid crystal displays (LCDs), by providing deeper black levels with thinner layers. In various examples, the OLED layer 310 may have a thickness of from about 0.1 mm to about 0.2 mm. In various examples, the thickness of the OLED layer 310 may be selected based on the needs of the device.

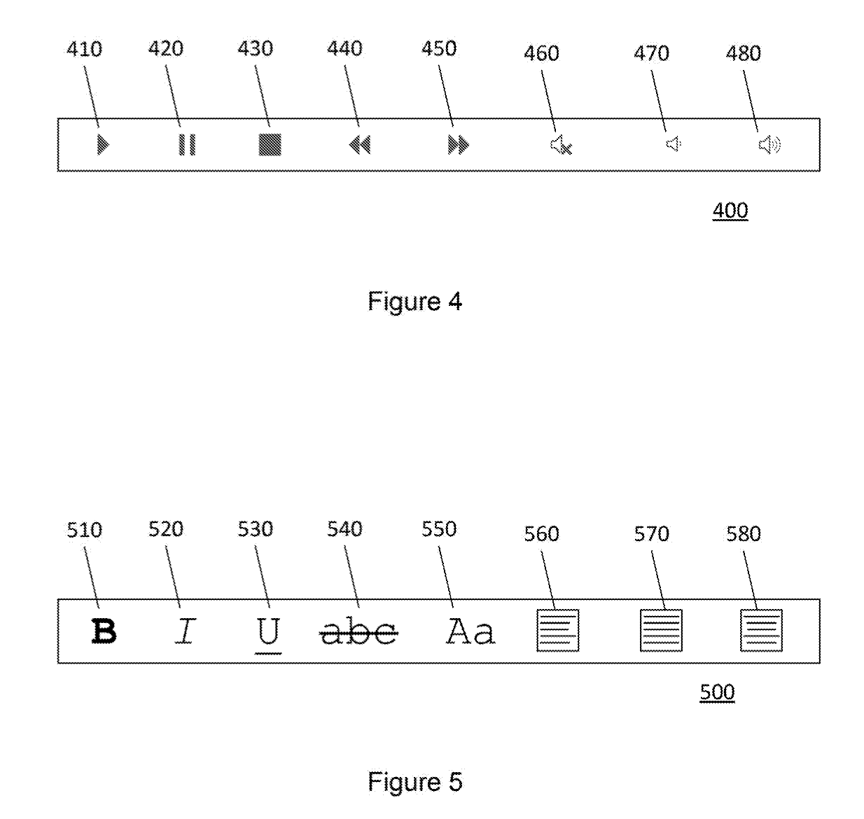

The display region of the OLED layer 310 may be used to variably display keys of any shape or size. For example, as illustrated in FIG. 3, various keys 330 of varying sizes may be displayed on the surface of the OLED layer 310. Further, in addition to the shape and size of the key regions 330, the content of the keys may be selected for particular applications, as illustrated below in greater detail with reference to FIGS. 4 and 5.

The OLED layer 310 is formed above a resistive touch layer 320. In various examples, the resistive touch layer 320 has a thickness between about 0.2 mm and about 0.3 mm. The resistive touch layer 320 can detect input from a user via a touch of a finger or a stylus, for example. In contrast to capacitive touch, the resistive touch layer 320 provides reduced latency and improved response time to the user's input. Additionally, the resistive touch layer 320 is activated only upon the application of a certain level of force. Thus, the force needed to activate the resistive touch layer can prevent accidental activation of the touch device.

The example touch input device 300 is also provided with a controller 340. In various examples, the controller 340 may the processor of the system, such as the CPU 110 of the system 100 shown in FIG. 1. In other examples, the controller 340 may be a dedicated controller for the touch input device 300 and communicates with the CPU 110 of the system 100 through the input/output interface 140. The controller 340 can control the display of the keys 330 on the OLED layer 310 and can detect an input to the resistive touch layer 320.

Thus, the combination of the OLED layer 310 and the resistive touch layer 320 provide the touch input device 300 with the ability to provide input keys or input regions of varying shapes and sizes. In various examples, the touch input device 300 can be used to display contextual keys 330 that are associated with a particular application that may be running on the system. In this regard, the touch input device 300 can be used to display keys that are specific to the application.

In various examples, program developers can dictate the keys that are displayed on the touch input device. Thus, developers can develop programs with specification for associated contextual keys to be displayed on the OLED layer 310 of the touch input device 300. In this regard, the touch input device 300 may be provided with application program interfaces (APIs) that may be used by program developers.

In other examples, a user interface may be provided to allow the user to customize the keys to be displayed on the OLED layer 310 of the touch input device 310. In this regard, the touch input device may be used to provide any keys specified by the user.

FIGS. 4 and 5 illustrate example contextual keys displayed on example touch input devices. Referring first to FIG. 4, the touch input device 400 is provided with contextual keys associated with a multimedia application, such as a video application. In this regard, the contextual keys may include a play key 410, pause key 420, stop key 430, reverse key 440, fast forward key 450, mute key 460, volume down key 470 and a volume up key 480. Of course, additional keys are possible and may be provided by the program developer, for example.

Referring now to FIG. 5, the touch input device 500 may be provided with contextual keys associated with a word processing application. In this regard, the contextual keys may include a bold key 510, italicize key 520, underline key 530, strike through key 540, change case key 550, left justification key 560, block format key 570 and a centered key 580. Again, additional keys are possible and may be provided by the program developer.

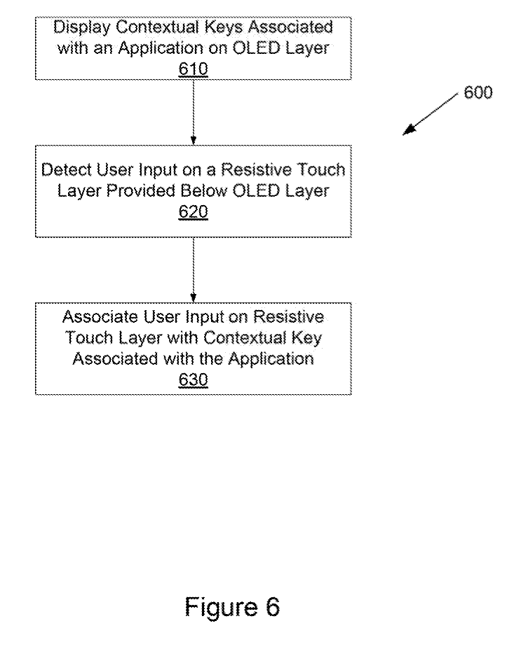

Referring now to FIG. 6, an example method is provided for using an input device having an OLED layer and a resistive touch layer. The example method 600 of FIG. 6 may be implemented on any input device having an OLED layer provided above a resistive touch layer, as described above with reference to FIG. 3, for example. Further, the example method 600 may be implemented on any system, such as a laptop, desktop, tablet, smartphone or any other electronic device.

In accordance with the example method 600, contextual keys associated with an application being run on a system, such as a laptop, may be displayed on an OLED layer, such as the OLED layer 310 shown in FIG. 3 (block 610). As described above, the contextual keys may have any size, shape or content as may be dictated by the application associated with the contextual keys. Further, the contextual keys may be associated with particular commands or functions associated with the application.

At block 620, a user input on the resistive touch layer may be detected by, for example, a controller associated with the resistive touch input device, such as the controller 330 of FIG. 3 or the CPU 110 of FIG. 1, for example. As described above, the resistive touch layer is positioned below the OLED layer. Thus, an input detected on the resistive touch layer may correspond to a contextual key displayed on the OLED

At block 630, the user input on the resistive touch layer is associated with a contextual key displayed on the OLED layer. As described above, the contextual keys are associated with the application. In this regard, the controller or the CPU may associate the user input with the contextual key and perform a function associated with the contextual key. For example, in a multimedia application, the controller or CPU may mute the volume if the user input is associated with the mute contextual key 460 of FIG. 4.

Thus, example resistive touch input devices in accordance with the present disclosure may provide contextual keys associated with a particular application. The contextual keys may have a size, shape and/or content determined in accordance with the particular application. Further, as described above, the combination of the OLED layer and the resistive touch layer allows contextualization or customization of the keys displayed on the input device. Additionally, latency in response time may be reduced due to the use of the resistive touch layer, while also reducing the likelihood of accidental activation of the keys.

The various examples set forth herein are described in terms of example block diagrams, flow charts and other illustrations. Those skilled in the art will appreciate that the illustrated examples and their various alternatives can be implemented without confinement to the illustrated examples. For example, block diagrams and their accompanying description should not be construed as mandating a particular architecture or configuration.

What is claimed is:

1. A system, comprising:
an input/output interface to receive inputs from one or more input devices; and
an input device to receive input from a user, the input device comprising:
a resistive touch layer; and
an organic light emitting diode (OLED) layer.

2. The system of claim 1, wherein the input device is integral with a keyboard.

3. The system of claim 1, further comprising a processor to display contextual keys on the OLED layer, the contextual keys being associated with an application executed by a processor.

4. The system of claim 3, wherein the contextual keys are associated with multimedia application.

5. The system of claim 3, wherein the contextual keys are associated with a word processing application.

6. The system of claim 4, wherein the input/output interface is to associate user input detected on the resistive touch layer with contextual keys displayed on the OLED layer.

7. A device, comprising:
a resistive touch layer to detect input from user;
an organic light emitting diode (OLED) layer formed above the resistive touch layer, the OLED layer to dynamically display contextual keys associated with an application, and
a controller to associate the input from the user with a contextual key displayed on the OLED layer.

8. The device of claim 7, wherein the contextual keys are associated with an application executed by a processor.

9. The device of claim 8, wherein the contextual keys are associated with a multimedia application.

10. The device of claim 8, wherein the contextual keys are associated with a word processing application.

11. The device of claim 7, wherein the device is integral with a keyboard.

12. A method, comprising:
displaying contextual keys associated with an application on an organic light emitting diode (OLED) layer;
detecting user input on a resistive touch layer provided below the OLED layer; and
associating the user input on the resistive touch layer with a contextual key associated with the application.

13. The method of claim 12, wherein the contextual keys are associated with a multimedia application.

14. The method of claim 12, wherein the contextual keys are associated with a word processing application.

15. The method of claim 12, wherein a size and a shape of the contextual keys is determined by the application.
